(19) United States
(12) Patent Application Publication
(10) Pub. No.: US 2013/0269044 A1
(43) Pub. Date: Oct. 10, 2013

(54) NON-INVASIVE SAFETY WRAPPER FOR COMPUTER SYSTEMS

(71) Applicant: Michael Pont, Leicester (GB)

(72) Inventor: Michael Pont, Leicester (GB)

(73) Assignee: TTE Systems Limited, Leicester (GB)

(21) Appl. No.: 13/641,924

(22) PCT Filed: Apr. 19, 2011
(86) PCT No.: PCT/GB2011/050769

§ 371 Date: Dec. 7, 2012

(30) Foreign Application Priority Data
Apr. 28, 2010 (GB) 1007068.8

(51) Int. Cl. G06F 15/80; G06F 21/86

(52) U.S. Cl. CPC G06F 15/80; G06F 21/86
USPC 726/34; 712/30

(57) ABSTRACT

A processing system comprising: a first processor adapted to perform one or more tasks according to a predetermined schedule and generate one or more first outputs; and a second processor synchronised with the first processor; wherein the second processor is adapted to receive the one or more first outputs and generate one or more corresponding second outputs when the timing of the one or more first outputs corresponds with the predetermined schedule.

### FIELD OF THE INVENTION

The present invention relates to an apparatus and a method which provides improved security and reliability for computer systems. In particular, the present invention relates to a non invasive safety wrapper for a processor (for example, a microcontroller or microprocessor), and a method of providing such a non invasive safety wrapper.

### BACKGROUND OF THE INVENTION

Embedded computer systems are widely used in a variety of applications ranging from brake controllers in passenger vehicles to multi-function mobile telephones. Deeply embedded systems may be thought of as such systems in which users would generally be unaware that the system was computer based. It is estimated that users encounter around 300 of such embedded systems every day while going about their day to day activities. Examples reside in cars, in aircraft, in medical equipment, in white and brown goods and even in toys.

Other uses of computer processor chips include “desktop” applications, such as air-traffic control and traffic management.

However, in many of these applications, there are concerns with regard to the microprocessors or microcontrollers of which these systems are comprised; for example the extent to which damage or tampering may take place that could compromise security or reliability of not only the computer processor chip but any systems which may rely thereon.

In such applications, it is desirable to ensure that the computer systems function correctly in the event that accidental errors (such as hardware failure and program errors that might be caused by electromagnetic interference or radiation-related errors) or malicious errors (for example as may be caused by deliberate attempts to effect behavioural changes) occur.

It is therefore an object of embodiments of the present invention to improve the security and reliability of such systems.

### SUMMARY OF THE INVENTION

According to a first aspect of the present invention, there is provided a processing system comprising:
a first processor adapted to perform one or more tasks according to a predetermined schedule and generate one or more first outputs; and
a second processor synchronised with the first processor;
wherein the second processor is adapted to receive the one or more first outputs and generate one or more corresponding second outputs when the timing of the one or more first outputs corresponds with the predetermined schedule.

The first and/or second processor may comprise a COTS microcontroller, microprocessor, DSP or FPGA. The first processor and the second processor may be implemented on separate chips or alternatively on separate soft or hard processor cores within a single processor.

Optionally, the first processor and the second processor are synchronised by a clock link which provides one or more timer ticks to either or both processors. Optionally, the second processor provides one or more timer ticks via the clock link to the first processor. Further alternatively, the first processor provides one or more timer ticks via the clock link to the second processor. Yet further alternatively, the system further comprises a clock source which provides one or more timer ticks via the clock link to both the first processor and the second processor.

Still further alternatively the timer ticks are provided by an external source such as an operating system configured to execute one or more tasks at predetermined times.

Optionally, the timer ticks are periodic.

Optionally, the clock link is achieved via external interrupts and/or serial interrupts. Optionally, the clock source comprises an oscillator circuit.

Optionally, the system further comprises a reset link by which the first processor can be reset.

Optionally, the second processor is configured to permit one or more outputs corresponding to tasks not constrained by the predetermined schedule to pass-through.

Preferably, the first processor and/or the second processor comprise a time-triggered scheduler driven by the one or more timer ticks. The time-triggered scheduler may be a time triggered cooperative (TTC) scheduler or a time triggered hybrid (TTH) scheduler.

Optionally, the system is configured to dynamically determine the timing of a timer tick corresponding to a particular task. Preferably, the second processor is configured to determine the timing of the timer tick dependent on the internal state of the first processor and generate said timer tick at the required time. Optionally, the timing of the timer tick is further dependent on parameters of a system in which the system of the present invention is embedded.

Optionally, task code being executed on the first processor is balanced and the second processor is configured to predict the timing of one or more of the first outputs dependent on the start time of one or more associated tasks. Optionally, the task code is balanced by employing a sandwich delay. Alternatively, the task code is balanced by employing single path programming.

Optionally, the system is configured to communicate information relating to the first processor to the second processor. Alternatively, or additionally, the system is configured to communicate information relating to the second processor to the first processor. Said information may comprise timer states of said processors.

Optionally, the one or more first outputs comprise one or more of digital outputs, pulse-width modulation outputs, SPI outputs, UART outputs and CAN outputs.

Preferably, the second processor is configured to store a representation of all or part of the predetermined schedule. Optionally, the second processor is configured to store a list of the one or more tasks being performed by the first processor.

Optionally, the second processor is further adapted to generate the one or more second outputs dependent on one or more parameters of the one or more first outputs. Said parameters may comprise minimum output values, maximum output values, rate-of-change of outputs and permitted output pins for tasks associated with said outputs. Preferably, output pins of the second processor correspond with output pins of the first processor.

Preferably, the second processor is configured to output a predetermined safe value in the event that one or more of the first outputs do not correspond with the predetermined schedule. Optionally, the second processor is further configured to initiate recovery of the first processor.

Alternatively, the second processor is configured to permit continued operation of the first processor provided the number of occurrences of first outputs which do not correspond with the predetermined schedule is below a threshold value.

According to a second aspect of the present invention, there is provided a safety wrapper for a first processor adapted to perform one or more tasks according to a predetermined schedule and generate one or more first outputs, the safety wrapper comprising a second processor to be synchronised with the first processor, to receive the one or more first outputs and generate one or more corresponding second outputs when the timing of the one or more first outputs corresponds with the predetermined schedule.

According to a third aspect of the present invention, there is provided a processing method comprising the steps of:

1. performing one or more processing tasks on a first processor according to a predetermined schedule and generating one or more first outputs; and

2. comparing the timing of the one or more first outputs with the predetermined schedule on a second processor; and

3. generating one or more second outputs corresponding to the one or more first outputs, from the second processor, dependent on the comparison.

Optionally, the method further comprises the step of synchronising the first processor and the second processor.

Optionally, the method further comprises the step of permitting one or more outputs corresponding to tasks not constrained by the predetermined schedule to pass-through.

Optionally, the method further comprises the step of dynamically determining the timing of a timer tick corresponding to a particular task.

Preferably, the step of determining the timing of the timer tick is dependent on the internal state of the first processor, and further comprises generating said timer tick at the required time. Optionally, the timing of the timer tick is further dependent on parameters of a system in which the system of the present invention is embedded.

Optionally, the method further comprises the step of balancing task code being executed on the first processor. Preferably, the step further comprises predicting the timing of one or more of the first outputs dependent on the start time of one or more associated tasks.

Optionally, the method further comprises communicating information relating to the first processor to the second processor. Alternatively, or additionally, the method further comprises communicating information relating to the second processor to the first processor.

Preferably, the method comprises the step of storing a representation of all or part of the predetermined schedule. Optionally, the method further comprises storing a list of the one or more tasks being performed by the first processor.

Optionally, the method comprises generating the one or more second outputs dependent on one or more parameters of the one or more first outputs. Said parameters may comprise minimum output values, maximum output values, rate-of-change of outputs and permitted output pins for tasks associated with said outputs.

Preferably, the method comprises outputting a predetermined safe value in the event that one or more of the first outputs do not correspond with the predetermined schedule. Optionally, the method further comprises the step of initiating recovery of the first processor.

Alternatively, the method comprises permitting continued operation of the first processor provided the number of occurrences of first outputs which do not correspond with the predetermined schedule is below a threshold value.

Preferably, the method further comprises the step of generating the predetermined schedule based on system code which causes the first processor to perform the one or more tasks.

According to a fourth aspect of the present invention, there is provided a method of providing a safety wrapper around a processor performing one or more processing tasks according to a predetermined schedule and generating one or more first outputs, the method comprising the steps of:

1. intercepting the one or more first outputs;

2. comparing the timing of the one or more first outputs with the predetermined schedule; and

3. generating one or more second outputs corresponding to the one or more first outputs dependent on the comparison.

According to a fifth aspect of the present invention, there is provided a computer program product containing one or more sequences of machine-readable instructions, the instructions being adapted to cause one or more processors to provide a processing system according to the first aspect.

According to a sixth aspect of the present invention, there is provided a computer program product containing one or more sequences of machine-readable instructions, the instructions being adapted to cause one or more processors to perform a processing method according to the second aspect.

According to a seventh aspect of the present invention, there is provided a computer program product containing one or more sequences of machine-readable instructions, the instructions being operable to adapt a computer to perform a method of providing a safety wrapper according to the fourth aspect.

### BRIEF DESCRIPTION OF THE FIGURES

The present invention will now be described by way of example only and with reference to the accompanying figures in which:

FIG. 1 illustrates in schematic form an embodiment of a processing system in which the target processor and the wrapper processor are synchronised by way of a clock link, in accordance with an aspect of the present invention;

FIG. 2 illustrates in schematic form an alternative embodiment of a processing system in which (a) the wrapper processor provides a tick source for the target processor and (b) the target processor provides a tick source for the wrapper processor, in accordance with an aspect of the present invention;

FIG. 3 illustrates in schematic form a further alternative embodiment of a processing system in which the target processor and the wrapper processor share a common clock source, in accordance with an aspect of the present invention;

FIG. 4 illustrates in schematic form the use of a sandwich delay to ensure that a particular activity occurs at a known time after the associated task begins;

FIG. 5 illustrates in schematic form another alternative embodiment of processing system in which the internal state of the target processor is communicated to the wrapper processor, in accordance with an aspect of the present invention; and

FIG. 6 illustrates in schematic form a yet further alternative embodiment of a processing system in which information regarding the timer states on the wrapper processor are communicated to the target processor, in accordance with an aspect of the present invention.

### DETAILED DESCRIPTION OF THE INVENTION

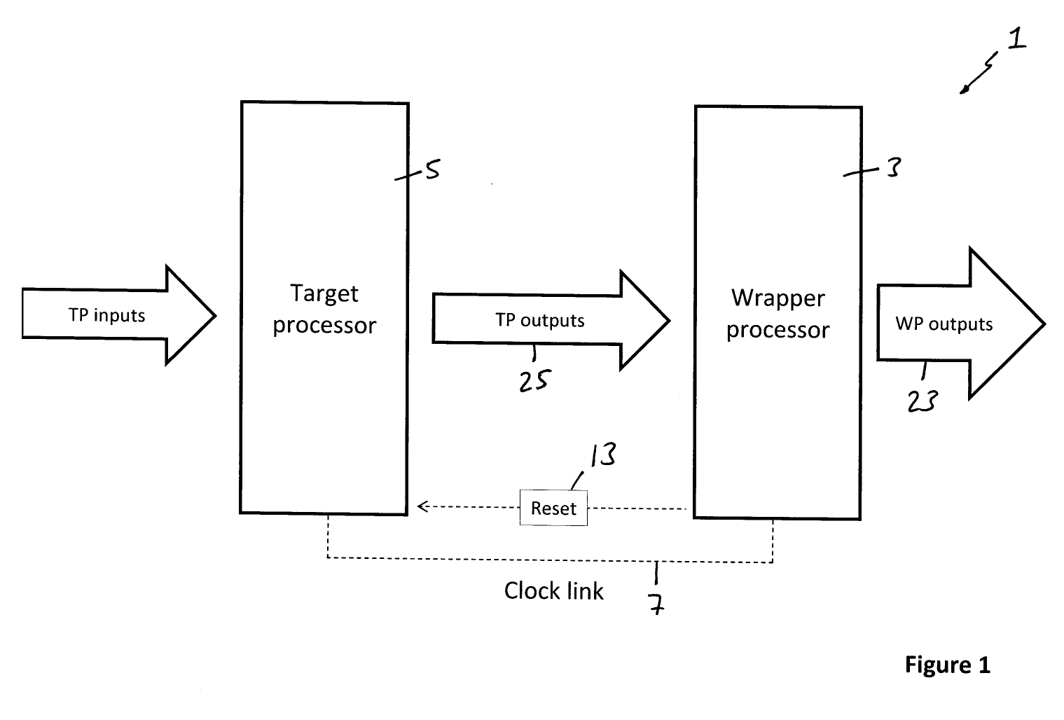

With reference to FIG. 1, there is presented a processing system 1 comprising a wrapper processor 3 which acts to effect a non-invasive safety wrapper (NISW) around a target processor 5. The wrapper processor 3 and the target processor 5 may comprise, for example, a COTS microcontroller, microprocessor, DSP or FPGA, and may be implemented on separate chips or on separate soft or hard processor cores within a single processor.

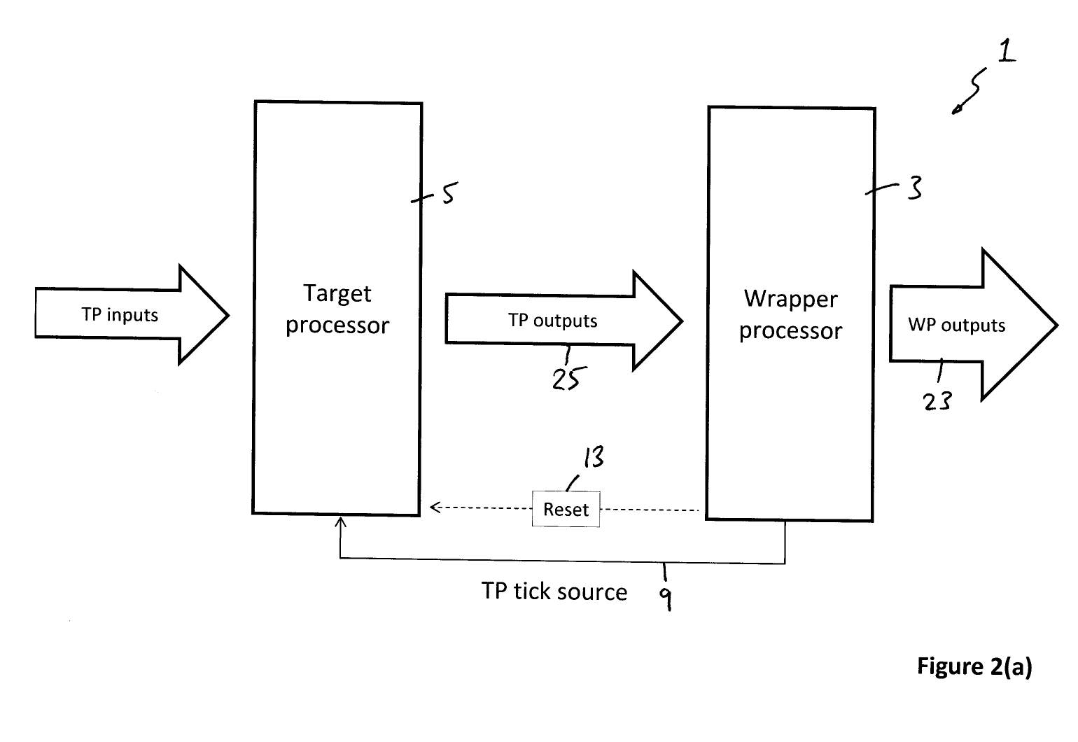

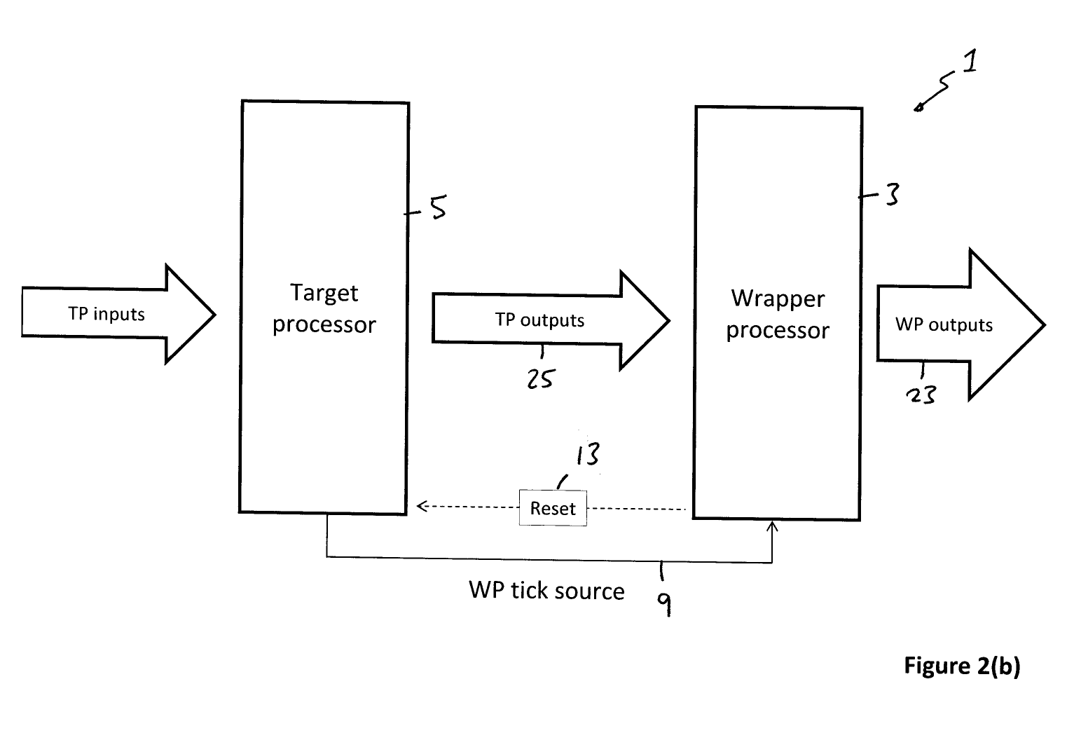

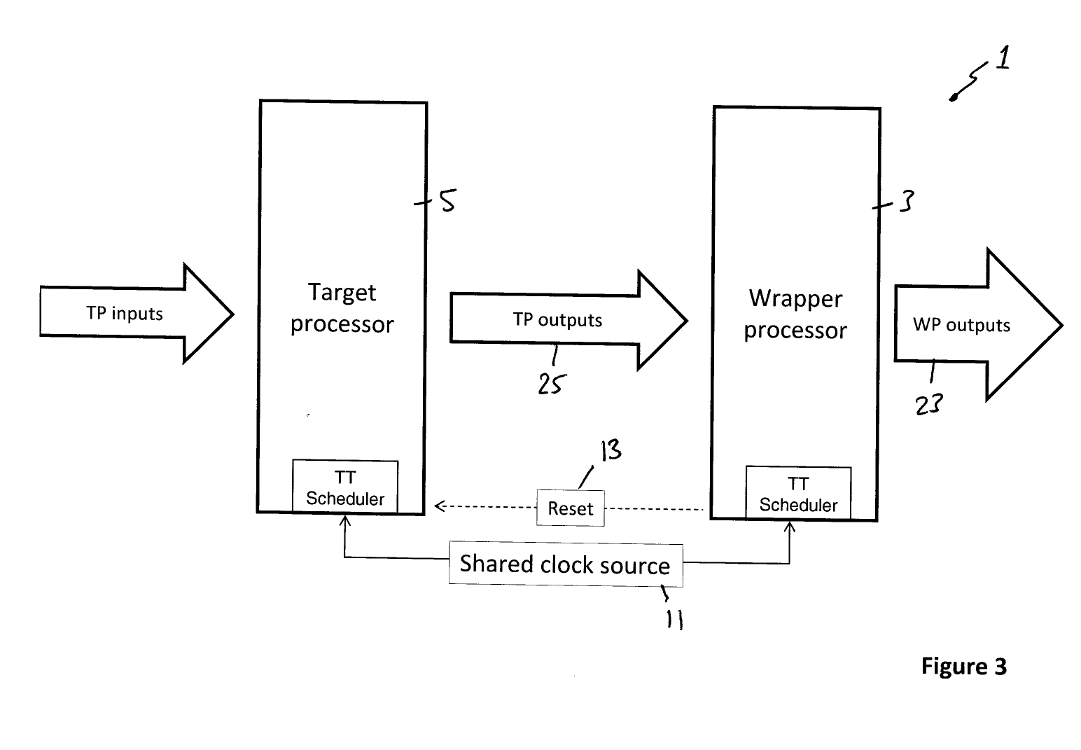

The target processor 5 and the wrapper processor 3 are synchronised, in this example by way of a clock link 7. FIG. 2 shows an example in which the wrapper processor 3 provides a tick source 9 to the target processor 5. Such links may be provided via external interrupts and serial interrupts, for example RS-232 or controller-area network (CAN) buses. Further examples may be found in Reference 8. An alternative embodiment is illustrated in FIG. 3 in which the target processor 5 and the wrapper processor 3 share a common external clock source 11, for example an oscillator circuit. FIGS. 1, 2 and 3 also illustrate schematically a reset link 13 which can be used to reset the target processor if required.

The system described is one in which in which the target processor 5 executes one or more key software tasks in accordance with pre-determined schedule: for example, the system may execute one or more periodic tasks. (The system may also execute other tasks which are not constrained by this predetermined schedule and which will not be monitored by the invention described here). As a consequence of these design features, it can be determined in advance what key task (if any) the target processor 5 should be carrying out at a particular time.

To facilitate this the target processor 5 may therefore be driven by periodic timer ticks which drive a time triggered cooperative (TTC) scheduler or a time triggered hybrid (TTH) scheduler or similar. In this implementation both the target processor 5 and the wrapper processor 3 will typically comprise a time triggered scheduler (as shown schematically in FIG. 3).

Alternatively, the target processor 5 may be driven by timer ticks which occur in a pre-determined sequence but are not necessarily (or always) periodic. For example, the second tick may occur 2 ms after the first tick, the third tick may occur 2.79 ms after the second tick, the fourth tick may occur 100 microseconds after the third tick, etc. These “time line” ticks may drive a time triggered cooperative (TTC) scheduler or a time triggered hybrid (TTH) scheduler or similar on the target processor. In this implementation both the target processor 5 and the wrapper processor 3 will typically comprise another time triggered which encapsulates knowledge of the task sequence and tick intervals.

Alternatively, the target processor 5 may be driven by timer ticks which drive a conventional (“desktop” or “real time”) operating system (such as Linux) which has been configured to run one or more tasks at pre-determined times. In this implementation, the wrapper processor 3 will typically comprise a time triggered scheduler.

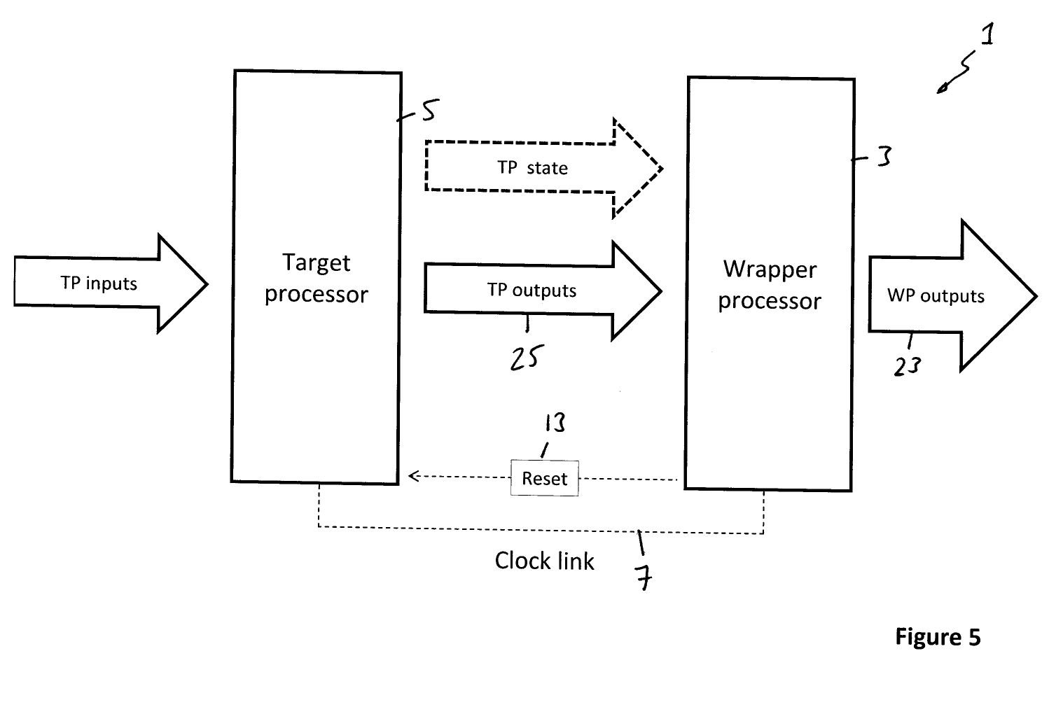

Alternatively the complete schedule may remain unknown, with the exception that, during the operation of the system—at a minimum—the time of the next tick will be known. The timing of the next tick may, in these circumstances, be determined dynamically (for example, in an automotive application it may depend on the speed of the vehicle or the speed of the engine). This will typically require that the Wrapper Processor is responsible for the generation of the ticks on the Target Processor, as shown in FIG. 2. The information about the Target Processor State (incl. the time until the next tick) may then be made available to the Wrapper Processor (as shown in FIG. 5). The Wrapper Processor will then generate this tick at the required time, and then check that the Target Processor generates the expected outputs in response to the generation of this tick. In such an implementation, the Wrapper Processor will typically be designed to ensure that changes in the interval between ticks are appropriate: for example, in an automotive application where the interval between ticks is related to the speed of the vehicle, very sudden or inconsistent changes in tick interval are likely to reflect some form of error.

In the above cases (whether a time-triggered scheduler or a conventional operating system is used), a fully pre-emptive task schedules may also be employed.

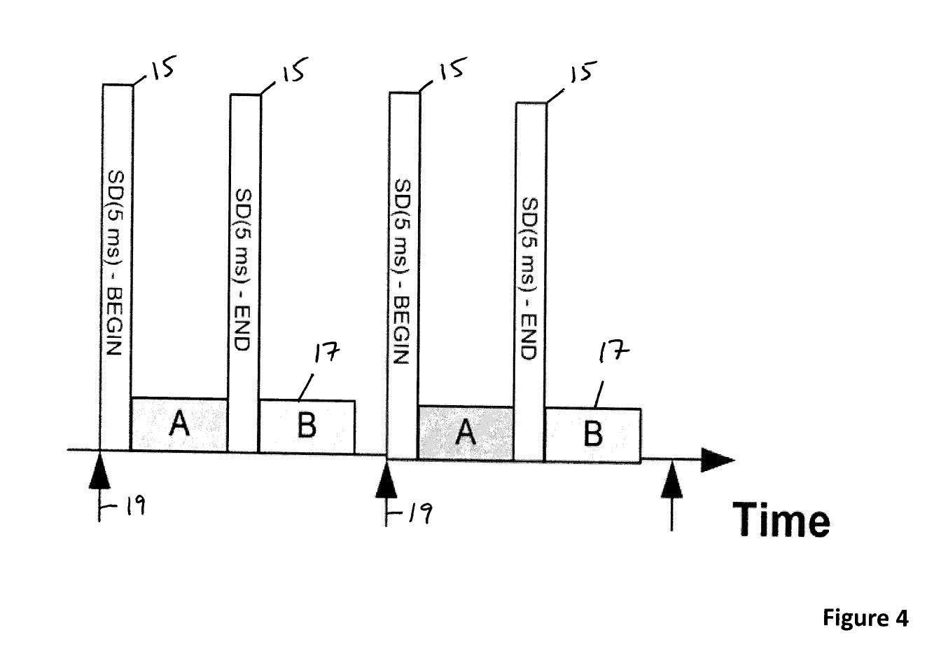

Reference 1 and Reference 8 provide non-limiting examples of the kinds of tasks that may be executed, for example “RS-232 data transmission”, “display updates” and “PID control” tasks. Other examples of tasks may involve reading input data, performing calculations and generating outputs.

Where the tasks generate outputs, it may be desirable to ensure not only that the tasks start at a predetermined time, but also that the outputs are generated at a known time interval following the start of the task. It may therefore be necessary to balance the task code. Balancing techniques include employing sandwich delays or single path programming (see References 1,5-7,9). FIG. 4 illustrates schematically the use of a sandwich delay 15 to ensure that activity B 17 always starts at a known time after the start time (indicated by arrow 19).

Note that the output of the target processor 5 may comprise one or more of output from digital output pins, pulse-width modulation output from digital pins, serial peripheral interface (SPI) outputs, universal asynchronous receiver/transmitter (UART) outputs, controller area network (CAN) outputs and the like.

As illustrated in FIGS. 1 to 3, 5 and 6, the wrapper processor 3 receives one or more outputs 25 from the target processor 5. Likewise, the wrapper processor 3 generates one or more outputs 23. These outputs 23 correspond with the outputs 25 from the target processor 25 when the timing of changes to the target processor outputs 25 occur at expected or predetermined times. To this end, the wrapper processor 3 stores a representation of part or all of the task schedule of the target processor 5.

In normal operation, the target processor output timings correspond with the task schedule and as such the wrapper processor 3 may simply copy the target processor output state to the wrapper processor output 23.

However, in the event of hardware failure, software errors, deliberate and/or malicious interference, or any host of problems which would compromise the safety and security of the target processor 5, the wrapper processor 3 will upon comparison with the task schedule of the target processor 5 determine that abnormal operation is occurring because the target processor output is not changing as expected.

One or more actions may then be performed by the wrapper processor 3 in response. The wrapper processor 3 will invariably not allow unexpected output from the target processor 5 to leave the system. Rather, the wrapper processor will generally output a predetermined safe value and optionally initiate recovery of the target processor 5. For example, the wrapper processor 3 may reset the target processor 5 (and maintain it in a reset state) by way of the reset link 13 illustrated.

The wrapper processor 3 may permit continued operation of the target processor 5 provided a predetermined number of errors or inconsistencies are not exceeded within a given time frame. For example, the wrapper processor 3 may permit no more than one such error or inconsistency per day. If the predetermined number is exceeded, the above reset may be implemented. Further steps may include indefinite suspension of the entire embedded system 1, perhaps pending complete reset by an external system or operator.

In addition to monitoring the timing of the target processor outputs 25, the wrapper processor 3 may monitor other parameters of the target processor outputs 25 to detect possible errors or inconsistencies. These parameters may include minimum and/or maximum output values, and the rate-of-change of output values. The above reset methods may be employed in the event of any combination of timings and parameters indicating unexpected behaviour of the target processor 5.

While the target processor 5 will typically store the entire code for the system, the wrapper processor 3 need not. However, the wrapper processor 3 will generally store a list of the tasks being performed by the target processor 5. This list may include details of the permitted output pins of the target processor 5 for a particular task. It may also include details of maximum and minimum values or permitted ranges of target processor output values.

It may be beneficial for the task code to be balanced, in which case the wrapper processor 3 may store details of the time for each task at which outputs are expected and hence permitted. Alternatively, output state changes may only be permitted when a corresponding task is executing for which such a change is expected. The wrapper processor 3 may therefore execute dummy tasks corresponding to the actual tasks being carried out by the target processor 5, which are intended to facilitate monitoring of the timing of the target processor output 25. A task schedule for the wrapper processor 3 may be generated directly from the task schedule for the target processor, in which case the task schedules can be compared during operation to ensure that the code is balanced.

It may be advantageous if the output pins of the wrapper processor 3 correspond with the output pins of the target processor 5. This may assist when the target processor 5 comprises complex digital output pins where

It is preferable to simply pass-through the complex signal rather than generate a corresponding complex signal. This also makes retro-fitting of the safety wrapper to an existing processor easier.

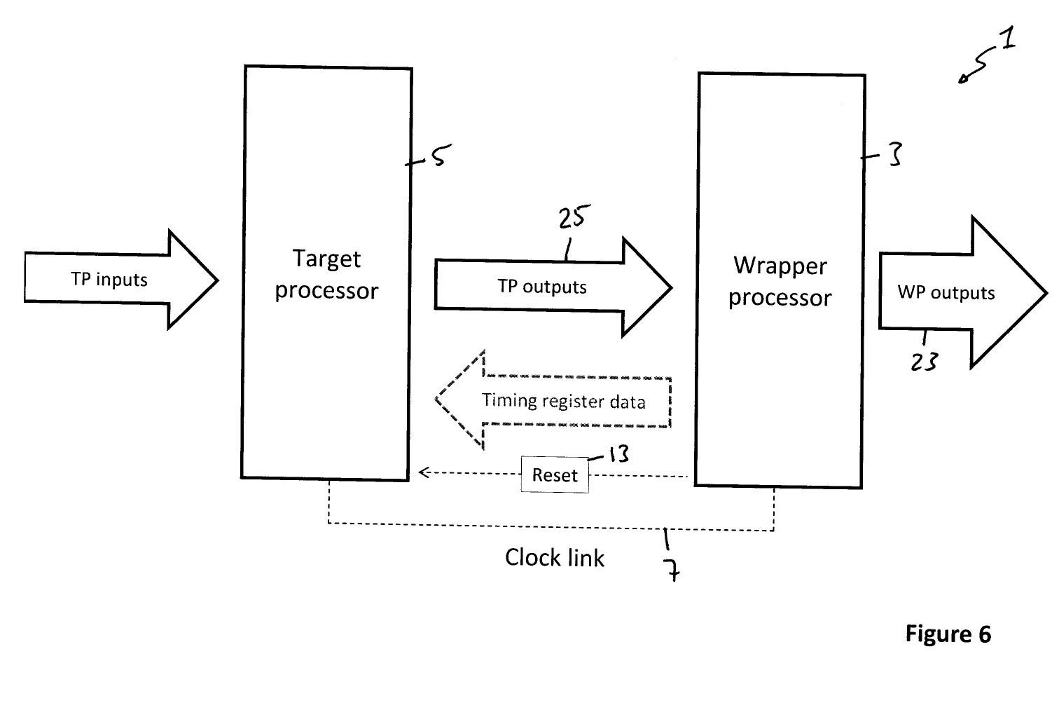

As illustrated in FIG. 5, additional information about the internal state of the target processor 5 may be communicated to the wrapper processor 3. This may facilitate more complex monitoring operations like checking for errors, e.g. task overruns, on the target processor 5. Particular output pins on the target processor 5 may communicate task start and end times to the wrapper processor 3. FIG. 6 illustrates an alternative embodiment in which additional information about the timer states on the wrapper processor 3 can be communicated to the target processor 5. This may provide support, for example, for a Timed Resource Access Protocol (TRAP) to be implemented in the embedded system, as described in Reference 2

The wrapper processor 3 effectively acts as a filter between the target processor 5 and any external systems to remove any unexpected or unwanted activity or behaviour. A major benefit therefore is that off-the-shelf processors can be employed in embedded systems as security intensive as aircraft and military systems without the need for detailed knowledge of the underlying processor design features (information which may be of a proprietary nature and very difficult to obtain) and/or where an off-the-shelf operating system is employed, because the wrapper processor 3 can be programmed to ensure that only desired performance of the target processor 5 is permitted.

The following code illustrates an example of how three periodic tasks may be configured on a target processor using a standard TTC scheduler:

void main(void)

{
SCH_TTC_Init( ); // Set up the scheduler
// Other init functions
// ...
// Add Task_A, Task_B and Task_C to the schedule
SCH_TTC_Add_Task(Task_A, 0, 1000);
SCH_TTC_Add_Task(Task_B, 100, 1000);
SCH_TTC_Add_Task(Task_C, 200, 1000);
SCH_TTC_Start( ); // Start the schedule
while(1)

{
SCH_TTC_Dispatch_Tasks( );
}

}

The following code illustrates an example of how the corresponding wrapper code may be configured on the wrapper processor using the same scheduler framework:

void main(void)

{
SCH_TTC_Init( ); // Set up the scheduler
// Other init functions
// ...
// Add WP_Task_A, WP_Task_B and WP_Task_C to the

schedule

SCH_TTC_Add_Task(WP_Task_A, 0, 1000);
SCH_TTC_Add_Task(WP_Task_B, 100, 1000);
SCH_TTC_Add_Task(WP_Task_C, 200, 1000);
SCH_TTC_Start( ); // Start the schedule
while(1)

{
SCH_TTC_Dispatch_Tasks( );
}

}

The following is an example of a task which may be run on the target processor:

void Task_A(void)

| | |
|---|---|
| { | |
| /* | Task_A has a known WCET of A milliseconds */ |
| /* | Task_A is not balanced */ |
| // | Read inputs |
| // | Perform calculations |
| /* | Starting at t <= A ms */ |
| // | Generate outputs |
| /* | Task_A completes within A milliseconds */ |
| } | |

In this case the code is not balanced but the worst-case execution time (WCET) of the task is known. Knowledge of WCET is a standard requirement for tasks in safety-related systems. In this case we know (only) that the task will generate certain outputs within A ms from the start of the task (where A is the known WCET of the task).

The below shows an alternative implementation of the task:

void Task_A(void)

| | |
|---|---|
| { | |
| /* | Task_A has a known WCET of A milliseconds */ |
| /* | Task_A is balanced */ |
| // | Read inputs (KNOWN AND FIXED DURATION) |
| // | Perform calculations (KNOWN AND FIXED DURATION) |
| /* | Starting at t = A1 ms, for a period of A2 ms */ |
| // | Generate outputs |
| /* | Task_A completes within A milliseconds */ |
| } | |

In this alternative implementation, the code in the task has been balanced. Where the code is balanced, it is possible to determine more precisely when particular task outputs will be generated (at a time or times measured relative to the start of the task): this, in turn, makes it easier to determine if actual tasks outputs follow the expected schedule. In the example shown above, the task outputs will be generated in an interval starting A1 ms after the start of the task and finishing A2 ms after the start of the task.

The following is an example of a task which could be scheduled in the WP to monitor the activity of the “unbalanced” version of Task_A (shown above):

void WP_Task_A(void)

{

| | |
|---|---|
| /* | WP_Task_A has a known WCET of A milliseconds */ |

while (t <= A ms)

{
// Read TP outputs
//
// Copy TP outputs (from Task A only) to WP

outputs

// - may check range, rate of change, of

outputs, etc

// - may take action if errors are detected
//
// Block all other TP outputs
// - may take action if erroneous outputs are

detected

| | } |
|---|---|
| /* | WP_Task_A completes within A milliseconds */ |
| } | |

This task will also monitor the activity of the other tasks on the TP (Task_B and Task_C in this example).

The following is an example of a task which could be scheduled in the WP to monitor the activity of the “balanced” version of Task_A (again, as shown above):

void WP_Task_A(void)

{

| | |
|---|---|
| /* | WP_Task_A has a known WCET of A milliseconds */ |

while (t < A1 ms)

{
// Read TP outputs
//
// Block all TP outputs
// - may take action if erroneous outputs are

detected

}

while (t <= A2 ms)

{
// Read TP outputs
//
// Copy TP outputs (from Task A only) to WP

outputs

// - may check range, rate of change, of

outputs, etc

// - may take action if errors are detected
//
// Block all other TP outputs
// - may take action if erroneous outputs are

detected

| | } |
|---|---|
| /* | WP_Task_A completes within A milliseconds */ |
| } | |

This will also monitor the activity of the other tasks on the TP (Task_B and Task_C in this example). As illustrated in this example, there is a close correspondence between both the task schedule on the TP and WP, and the task designs on the TP and WP. This makes it easy to generate the required WP code automatically (or semi-automatically) using the TP code as a template.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

Further modifications and improvements may be added without departing from the scope of the invention herein described/defined by the appended claims. For example, where examples above are presented in the context of time-triggered and/or time-triggered embedded systems, it will be readily appreciated that the invention is equally applicable to any system comprising any kind of processor.

### REFERENCES

1. K. Gendy and M. J. Pont “Towards a generic “Single Path Programming” solution with reduced power consumption,” in International Design Engineering Technical Conferences & Computers and Information in Engineering Conference IDETC/CIE 2007, Las Vegas, Nev., USA, 2007.
2. Adi Maaita (PhD 2008, University of Leicester) “Techniques for Enhancing the Temporal Predictability of Real-Time Embedded Systems Employing a Time-Triggered Software Architecture”.
3. M. J. Pont Embedded C: Addison-Wesley, 2002.
4. Pont, M. J. and Chan, K. L. (2007) “Non-invasive safety agent for use with time-triggered systems” (filed UK, 11 May 2007: now at PCT stage).
5. P. Puschner and A. Burns, “Writing temporally predictable Code,” in Proceedings of the seventh International Workshop on Object-Oriented Real-Time Dependable Systems, 2002.
6. P. Puschner, “Is WCET Analysis a non-problem? Towards new Software and Hardware architectures,” in 2nd International Workshop on Worst Case Execution Time Analysis, Vienna, Austria, June 2002.
7. R. Kirner and P. Puschner, “Discussion of Misconceptions about WCET Analysis,” in 3rd Euromicro International workshop on WCET Analysis, 2003.
8. M. J. Pont Patterns for Time-Triggered Embedded Systems: ACM press, 2001.
9. M. J. Pont, S. Kurian, and R. Bautista-Quintero, “Meeting Real-time Constraints Using “Sandwich Delays”,” TPLOP, LNCS, pp. 94-102, 2009.

1. A processing system comprising:
a first processor adapted to perform one or more tasks according to a predetermined schedule and generate one or more first outputs;
a second processor synchronised with the first processor; and
wherein the second processor is adapted to receive the one or more first outputs and generate one or more corresponding second outputs when the timing of the one or more first outputs corresponds with the predetermined schedule.

2. A processing system according to claim 1, wherein the first processor and the second processor are implemented on separate chips or on separate soft or hard processor cores within a single processor.

3. A processing system according to claim 1, wherein the first processor and the second processor are synchronised by a clock link which provides one or more timer ticks to either or both processors.

4. A processing system according to claim 3, wherein the second processor provides one or more timer ticks via the clock link to the first processor.

5. A processing system according to claim 3, wherein the first processor provides one or more timer ticks via the clock link to the second processor.

6. A processing system according to claim 3, wherein the system further comprises a clock source which provides one or more timer ticks via the clock link to both the first processor and the second processor.

7. A processing system according to claim 3, wherein the timer ticks are provided by an operating system configured to execute one or more tasks at predetermined times.

8. A processing system according to claim 3, wherein the clock link is achieved via external interrupts and/or serial interrupts.

9. A processing system according to claim 6, wherein the clock source comprises an oscillator circuit.

10. A processing system according to claim 1, wherein the system further comprises a reset link by which the first processor can be reset.

11. A processing system according to claim 1, wherein the second processor is configured to permit one or more outputs corresponding to tasks not constrained by the predetermined schedule to pass-through.

12. A processing system according to claim 3, wherein the first processor and/or the second processor comprise a time-triggered scheduler driven by the one or more timer ticks.

13. A processing system according to claim 3, wherein the system is configured to dynamically determine the timing of a timer tick corresponding to a particular task.

14. A processing system according to claim 13, wherein the second processor is configured to determine the timing of the timer tick dependent on the internal state of the first processor and generate said timer tick at the required time.

15. A processing system according to claim 13, wherein the timing of the timer tick is further dependent on parameters of a system in which the system of the present invention is embedded.

16. A processing system according to claim 1, wherein task code being executed on the first processor is balanced and the second processor is configured to predict the timing of one or more of the first outputs dependent on the start time of one or more associated tasks.

17. A processing system according to claim 16, wherein the task code is balanced by employing a sandwich delay or single path programming.

18. A processing system according to claim 1, wherein the system is configured to communicate information relating to the first processor to the second processor, and/or wherein the system is configured to communicate information relating to the second processor to the first processor.

19. A processing system according to claim 18, wherein the information comprises timer states of one or both of the processors.

20. A processing system according to claim 1, wherein the second processor is configured to store a representation of all or part of the predetermined schedule.

21. A processing system according to claim 1, wherein the second processor is configured to store a list of the one or more tasks being performed by the first processor.

22. A processing system according to claim 1, wherein the second processor is further adapted to generate the one or more second outputs dependent on one or more parameters of the one or more first outputs.

23. A processing system according to claim 1, wherein output pins of the second processor correspond with output pins of the first processor.

24. A processing system according to claim 1, wherein the second processor is configured to output a predetermined safe value in the event that one or more of the first outputs do not correspond with the predetermined schedule.

25. A processing system according to claim 1, wherein the second processor is further configured to initiate recovery of the first processor.

26. A processing system according to claim 1, wherein the second processor is configured to permit continued operation of the first processor provided the number of occurrences of first outputs which do not correspond with the predetermined schedule is below a threshold value.

27. A safety wrapper for a first processor adapted to perform one or more tasks according to a predetermined schedule and generate one or more first outputs, the safety wrapper comprising a second processor to be synchronised with the first processor, to receive the one or more first outputs and generate one or more corresponding second outputs when the timing of the one or more first outputs corresponds with the predetermined schedule.

28. A processing method comprising the steps of:
a. performing one or more processing tasks on a first processor according to a predetermined schedule and generating one or more first outputs;
b. on a second processor, comparing the timing of the one or more first outputs with the predetermined schedule; and
c. generating one or more second outputs from the second processor corresponding to the one or more first outputs, dependent on the comparison.

29. A processing method according to claim 28, wherein the method further comprises the step of synchronising the first processor and the second processor.

30. A processing method according to claim 28, wherein the method further comprises the step of permitting one or more outputs corresponding to tasks not constrained by the predetermined schedule to pass-through.

31. A processing method according to claim 28, wherein the method further comprises the step of dynamically determining the timing of a timer tick corresponding to a particular task.

32. A processing method according to claim 31, wherein the step of determining the timing of the timer tick is dependent on the internal state of the first processor, and further comprises generating said timer tick at the required time.

33. A processing method according to claim 31, wherein the timing of the timer tick is dependent on parameters of a system in which the system of the present invention is embedded.

34. A processing method according to claim 28, wherein the method further comprises the step of balancing task code being executed on the first processor.

35. A processing method according to claim 34, wherein the step further comprises predicting the timing of one or more of the first outputs dependent on the start time of one or more associated tasks.

36. A processing method according to claim 28, wherein the method further comprises communicating information relating to the first processor to the second processor, and/or wherein the method further comprises communicating information relating to the second processor to the first processor.

37. A processing method according to claim 28, wherein the method comprises the step of storing a representation of all or part of the predetermined schedule.

38. A processing method according to claim 28, wherein the method further comprises storing a list of the one or more tasks being performed by the first processor.

39. A processing method according to claim 28, wherein the method comprises generating the one or more second outputs dependent on one or more parameters of the one or more first outputs.

40. A processing method according to claim 28, wherein the method comprises outputting a predetermined safe value in the event that one or more of the first outputs do not correspond with the predetermined schedule.

41. A processing method according to claim 28, wherein the method further comprises the step of initiating recovery of the first processor.

42. A processing method according to claim 28, wherein the method comprises permitting continued operation of the first processor provided the number of occurrences of first outputs which do not correspond with the predetermined schedule is below a threshold value.

43. A processing method according to claim 28, wherein the method further comprises the step of generating the predetermined schedule based on system code which causes the first processor to perform the one or more tasks.

44. A method of providing a safety wrapper around a processor performing one or more processing tasks according to a predetermined schedule and generating one or more first outputs, the method comprising the steps of:
a. intercepting the one or more first outputs;
b. comparing the timing of the one or more first outputs with the predetermined schedule; and
c. generating one or more second outputs corresponding to the one or more first outputs dependent on the comparison.

45. A computer program product containing one or more sequences of machine-readable instructions, the instructions being adapted to cause one or more processors to provide a processing system according to claim 1.

46. A computer program product containing one or more sequences of machine-readable instructions, the instructions being adapted to cause one or more processors to perform a processing method according to claim 28.

47. A computer program product containing one or more sequences of machine-readable instructions, the instructions being operable to adapt a computer to perform a method of providing a safety wrapper according to claim 44.
